(19) United States
(12) Patent Application Publication
(10) Pub. No.: US 2025/0187008 A1
(43) Pub. Date: Jun. 12, 2025

(54) MICROFLUIDIC DEVICE AND METHOD FOR EMULSION SWITCHING

(71) Applicant: The Board of Trustees of the University of Illinois, Urbana, IL (US)

(72) Inventors: Hee-Sun HAN, Champaign, IL (US); Thomas W. COWELL, Houston, TX (US)

(21) Appl. No.: 18/968,435

(22) Filed: Dec. 4, 2024

Related U.S. Application Data
(60) Provisional application No. 63/608,512, filed on Dec. 11, 2023.

(51) Int. Cl. B01L 3/00

(52) U.S. Cl. CPC B01L 3/502784; B01L 2200/06; B01L 2200/16; B01L 2300/0883; B01L 2400/0424

(57) ABSTRACT

A microfluidic device for emulsion switching includes a channel comprising: an inlet for injection of double emulsion droplets; an emulsion switching feature downstream of the inlet for converting the double emulsion droplets directly or indirectly into single emulsion droplets; a manipulation portion downstream of the emulsion switching feature for manipulating and/or modifying the single emulsion droplets, the manipulation portion including a non-wetting inner surface configured to avoid wetting of the single emulsion droplets; and a reforming portion downstream of the manipulation portion for reforming double emulsion droplets from the manipulated or modified single emulsion droplets.

### RELATED APPLICATION

The present patent document claims the benefit of priority under 35 U.S.C. 119(e) to U.S. Provisional Patent Application No. 63/608,512, which was filed on Dec. 11, 2023, and is hereby incorporated by reference in its entirety.

### TECHNICAL FIELD

The present disclosure is related generally to droplet microfluidics and more particularly to a microfluidic device and method for emulsion switching.

### BACKGROUND

Emulsion droplets have been shown to have a wide variety of uses and applications in high-throughput screening of biological samples, fabrication of microparticles and microcapsules, single molecule detection, single-cell sequencing, bioanalytical assays, etc. Single emulsion droplets are widely used for these applications but require expensive surfactants and skillful handling to ensure drop stability throughout a given workflow. Double emulsions have been found to function similarly to single emulsions with the added benefit of significantly improved stability. Double emulsions are also more useful than single emulsions due to their compatibility with existing flow cytometry techniques. A key limitation that prevents widespread replacement of single emulsion drops with double emulsions is a lack of technologies that can actively manipulate double emulsion drops in a high-throughput manner. Existing technologies do not allow for on-demand addition of reagents or aqueous contents to double emulsions in a controlled way. Consequently, double emulsions have been incompatible with reagent addition steps (e.g., drop merging or picoinjection) in many drop microfluidic processes.

### BRIEF DESCRIPTION OF THE DRAWINGS

FIG. 1 demonstrates emulsion switching of double emulsion droplets to single emulsion droplets, followed by reagent addition and then reforming of the double emulsion droplets.

FIG. 2 demonstrates emulsion switching followed by droplet merging and then reforming of the double emulsions.

FIG. 3 demonstrates emulsion switching followed by droplet splitting and then reforming of the double emulsions.

FIGS. 4 and 5 demonstrate emulsion switching followed by droplet sorting with optional reforming of the double emulsions.

FIG. 6 demonstrates emulsion switching with an alternative approach for reagent addition, where the double emulsion is destabilized prior to exposure to a fluorophilic fluid.

FIG. 7 demonstrates emulsion splitting with an alternative approach for reagent addition, where destabilization takes place after exposure to a fluorophilic fluid.

FIG. 8 demonstrates an alternative approach to emulsion switching involving spontaneous release.

FIG. 9A shows the design of a microfluidic device including a channel that takes as input double emulsion drops, manipulates them via pico-injection, and reforms a new double emulsion output. Portions of the channel including fluorophilic/hydrophobic and hydrophilic inner surfaces are indicated.

FIG. 9B is an image illustrating the flow confinement strategy used during hydrophilic surface treatment to form the hydrophilic inner surface(s) of the channel. Water restricts the injected polyelectrolyte solutions to treat only the double emulsion junction and the downstream channel towards the device outlet.

FIG. 9C is an image illustrating the flow confinement strategy used during fluorophilic surface treatment (e.g., Aquapel®). A flow of hydrofluoroether (HFE) prevents the Aquapel from disrupting the previously applied hydrophilic coating at the outlet.

FIG. 10A shows suitable double emulsion droplet sizes for controlled core release.

FIG. 10B shows suitable operation conditions for double emulsion (DE) formation. A relatively large range of drop sizes can be successfully encapsulated across various flow rates. For example, irregular streams of DE cores between 55 microns and 68 microns can be formed into high-quality DEs at low outer aqueous phase (OA) flow rates.

FIG. 10C shows suitable double emulsion droplet sizes relative to channel height at the inlet for successful reinjection.

FIG. 10D shows suitable double emulsion droplet sizes relative to constriction width for controlled core release behavior.

FIGS. 11A and 11B show operation of drop-by-drop reagent addition to a double emulsion, where the close-packed DE drops are respaced to form an unstable triple emulsion (W/O/W/O); in the constricted channel with fluorophilic surface functionalization, these drops de-wet and release their aqueous cores. Reagent(s) may be introduced into the stream of W/O drops by pico-injection and added to each W/O drop. The stream of processed SE drops travels towards the hydrophilic portion of the microfluidic device where they are further encapsulated to form DE drops.

FIG. 12A shows a composite image of the double emulsion input drops, where each 37-μm core contains TexasRed fluorescence signals.

FIG. 12B shows a DE output collected from the reagent addition device. Drops containing mixed signals from TexasRed labeled cores and FITC labeled reagent stream appear yellow. Some excess reagent drops (FITC only) appear as green DEs.

FIG. 12C shows a drop size histogram of the aqueous cores of the input DE and the aqueous cores of the output DE as well as the total size of the DE output (n=154). After reagent addition, the variation in drop size increases but remains monodisperse with a coefficient of variation <10% (6.65%).

FIG. 13A shows a schematic representation of two-step double emulsion screening of a light-up aptamer library.

FIG. 13B shows DE drops after ddPCR amplification from single copy templates encoding the library of aptamer sequences.

FIG. 13C shows the DE drops after processing by the reagent adder and collection as a new double emulsion with added reagents needed for T7 synthesis of RNA aptamers.

FIGS. 13D and 13E show associated fluorescence data.

FIG. 13F shows Sanger sequencing results from the aptamer screen, where sorting recovers the correct broccoli sequence.

### DETAILED DESCRIPTION

Described in this disclosure is a microfluidic device and method for controllably manipulating double emulsion droplets to accomplish a variety of functions/operations that have not been possible previously. Double emulsion droplets, which may also be referred to as “double emulsion drops” or “double emulsions,” may include an aqueous droplet core surrounded by an immiscible organic shell suspended in a continuous aqueous volume, e.g., water-in-oil-in-water (W/O/W) double emulsions. The structure of double emulsions usually limits the addition of aqueous material, as any added volume must pass across the organic shell of the double emulsion droplet. This disclosure describes methods to directly and indirectly convert double emulsion droplets into single emulsion droplets for on-chip manipulation using existing or new methods, followed by re-encapsulation as double emulsion droplets. This technology facilitates sequential reaction steps using double emulsions, a critical advancement towards many potential biological or biochemical applications for double emulsion drop microfluidics.

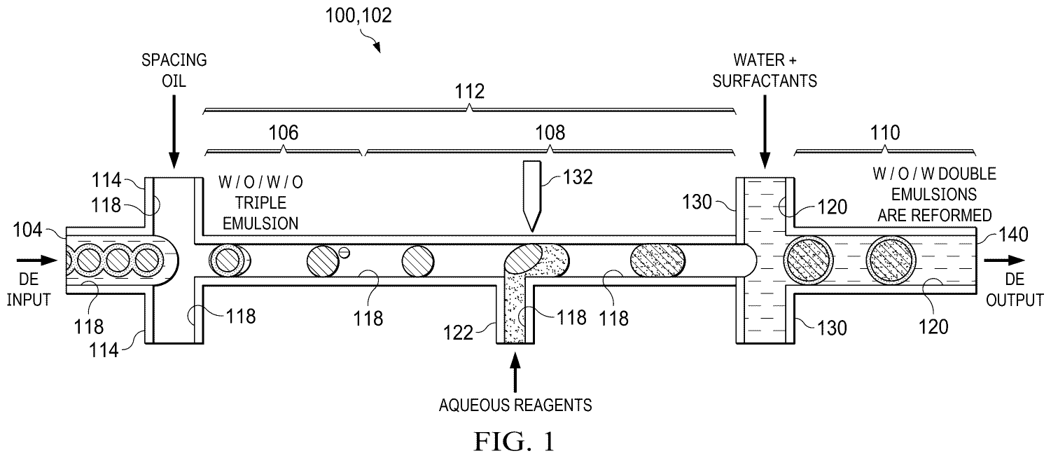

Various embodiments of the microfluidic device and implementations of the method are illustrated in the schematics of FIGS. 1 to 8. Referring to these figures, the microfluidic device or chip 100 includes a channel 102 comprising an inlet 104 for injection of double emulsion droplets. An emulsion switching feature 106 is located downstream of the inlet 104 for converting the double emulsion droplets directly or indirectly into single emulsion droplets. A manipulation portion 108 of the channel 102 having a fluorophilic and/or hydrophobic inner surface 118 is downstream of the emulsion switching feature 106 for manipulating and/or modifying the single emulsion droplets, and a reforming portion 110 of the channel 102 having a hydrophilic inner surface 120 is downstream of the manipulation portion 108 for reforming double emulsion droplets from the manipulated or modified single emulsion droplets. The injected double emulsion droplets may be referred to as a double emulsion (DE) input into the channel of the microfluidic device, and the reformed double emulsion droplets may be referred to as a DE output.

Examples of the microfluidic device and method described below are directed to processing double emulsion droplets comprising an aqueous core surrounded by an organic fluid shell in a continuous aqueous fluid or phase (e.g., W/O/W double emulsions). However, the device and method are applicable also to processing double emulsion droplets comprising an organic fluid core surrounded by an aqueous shell in a continuous organic fluid or phase (e.g., O/W/O double emulsions). In such examples, surfaces that are fluorophilic and/or hydrophobic in the examples below may instead be hydrophilic, and surfaces that are hydrophilic in the examples below may instead be fluorophilic and/or hydrophobic. Accordingly, the microfluidic device and method may have alternative configurations and implementations as set forth in the aspects below.

Also, it is noted that the term “fluorophilic and/or hydrophobic inner surface” may refer to one or more fluorophilic and/or hydrophobic inner surfaces 118 of the channel, depending on the geometry of the channel. Similarly, the term “hydrophilic inner surface” may refer to one or more hydrophilic inner surfaces 120 of the channel, depending on the geometry of the channel. For example, for a channel having a rectangular transverse cross-section, the fluorophilic and/or hydrophobic (hydrophilic) inner surface may include top, bottom, and/or side fluorophilic and/or hydrophobic (hydrophilic) inner surfaces 118 (120) that extend over the length of the manipulation (reforming) portion 108 (110). The lengths of the manipulation and reforming portions 108,110 of the channel 102 may be the same or different.

The emulsion switching feature 106 may be any feature or stimulus capable of destabilizing the double emulsion droplets such that the inner core is released from the surrounding fluid shell as a single emulsion. The emulsion switching feature 106 may comprise a physical, electrical, or chemical stimulus, for example, to promote release of the inner core. More specifically, the electrical stimulus may comprise a nearby electrode applying a high voltage AC pulse, which may result in electro-coalescence of the droplet. The chemical stimulus may comprise a chemical demulsifier. The physical stimulus may comprise a thermal stimulus, such as a heating element, an electromagnetic stimulus, such as laser irradiation or a mechanical stimulus, such as a pressure wave or impulse. In some examples, the physical stimulus may comprise a channel constriction 112, that is, a reduction of the width, height and/or cross-sectional area of the channel 102 compared to an upstream width, height and/or cross-sectional area. For example, the cross-sectional area of the channel 102 may constrict to about 80% or less of the upstream cross-sectional area, to about 65% or less of the upstream cross-sectional area, or to about 50% or less of the upstream cross-sectional area, e.g., from about 40% to about 80% of the upstream cross-sectional area. The channel constriction 112 may be sized to shear an outer layer of the double emulsion droplets (or triple emulsion droplets in some examples, as discussed below), thereby destabilizing the double/triple emulsion droplets and enabling single emulsion droplets (e.g., water-in-oil or W/O single emulsion droplets) to be formed. The emulsion switching feature 106 may be described as being located at the upstream-most location of the channel constriction 112, that is, at the initiation site of the reduction in width, height, or other dimension, although the channel constriction 112 itself may extend downstream along part or all of the length of the manipulation portion 108.

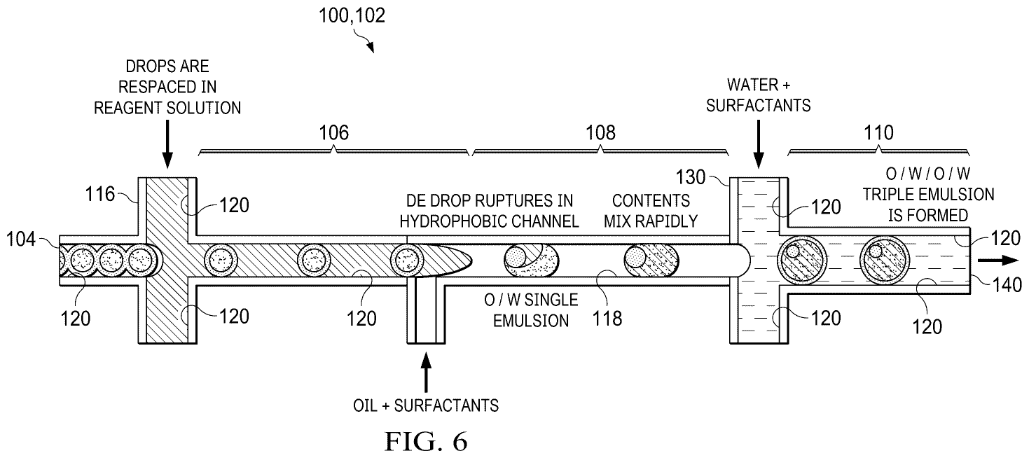

As illustrated in examples below, the inlet 104 of the channel 102 may comprise a fluorophilic and/or hydrophobic inner surface (FIGS. 1-5) or a hydrophilic inner surface (FIGS. 6-8). Accordingly, in one example, the channel 102 may further comprise a junction 114 for introduction of an organic spacing fluid located downstream of the inlet 104 and upstream of the emulsion switching feature 106 (e.g., FIG. 1); in another example, the channel 102 may further comprise a junction 116 for introduction of an aqueous spacing fluid located downstream of the inlet 104 and upstream of the emulsion switching feature 106 (e.g., FIG. 6). In the former example, the junction 114 may have a fluorophilic and/or hydrophobic inner surface 118, and in the latter example, the junction 116 may have a hydrophilic inner surface 120. The channel 102 may also or alternatively comprise, located within the manipulation portion 108, a junction 122 for introduction of an aqueous reagent fluid or an additional population of single emulsion droplets. The organic spacing fluid may comprise a fluorinated organic compound, such as a hydrofluoroether oil such as Novec™ HFE-7500, a perfluorocarbon such as Fluorinert™ FC-40, or another perfluoroinated hydrocarbon. The aqueous spacing or reagent fluid may comprise, for example, cell culture media and buffers, molecular biology reagents and buffers, water-soluble monomers, polymers or pre-polymers, and/or another aqueous phase system.

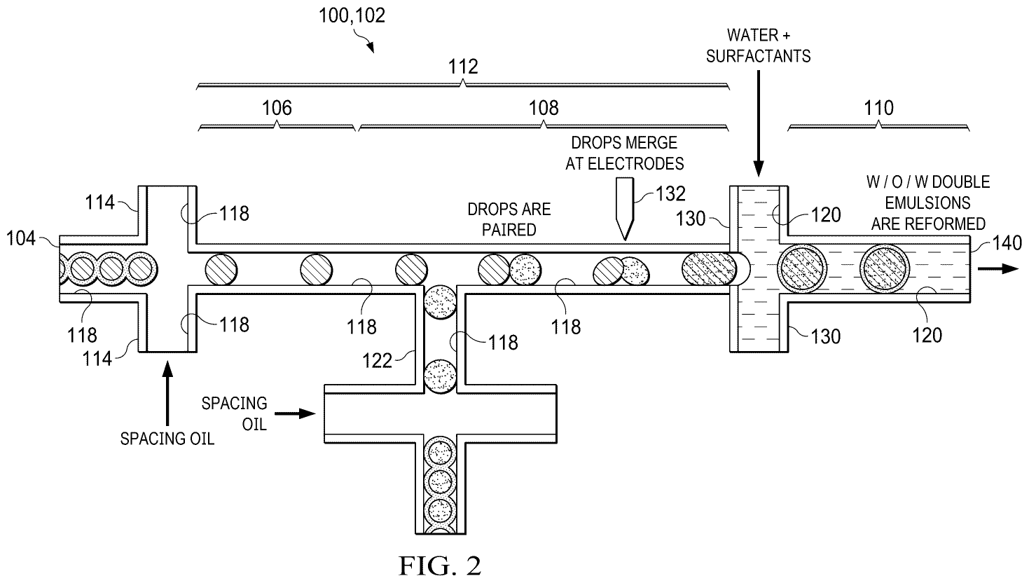

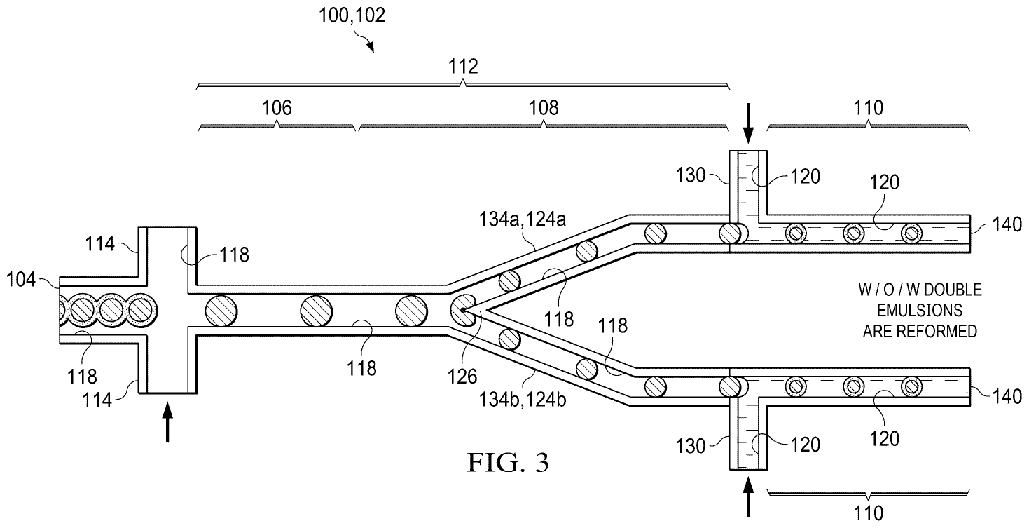

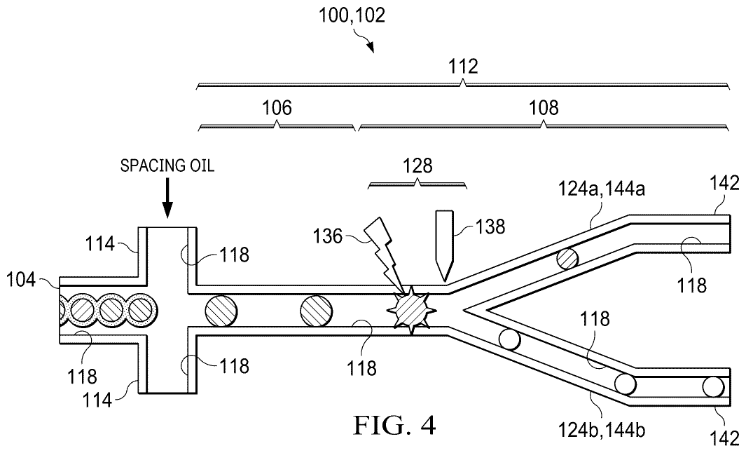

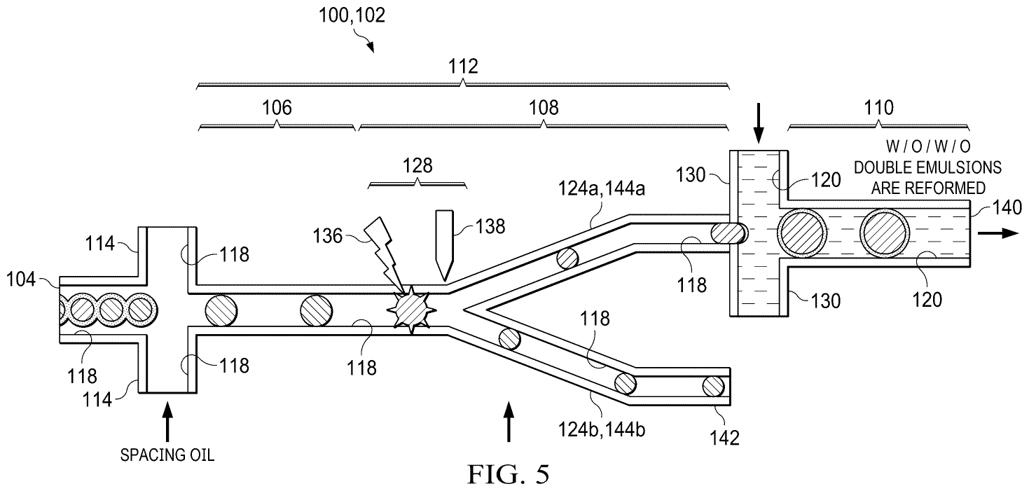

The manipulation portion 108 of the channel 102 may be configured to implement drop-by-drop manipulation techniques such as pico-injection, drop merging, drop splitting, and drop sorting. In some examples, the channel 102 may further include, positioned within the manipulation portion 108, a junction 122 for introduction of an aqueous reagent fluid or an additional population of single emulsion droplets (e.g., see FIGS. 1 and 2). Also or alternatively, the channel 102 may include two or more downstream branches 124a, 124b in the manipulation portion 108, as shown for example in FIGS. 3-5. At least one of the two or more downstream branches 124a, 124b may terminate in the reforming portion 110. The channel 102 may include a drop splitting feature 126 immediately upstream or at the origination point of the two or more downstream branches 124a, 124b, as illustrated in FIG. 3. In some examples, the channel 102 may include a screening and sorting device 128 immediately upstream of the two or more downstream branches 124a, 124b, as shown in FIGS. 4 and 5.

To facilitate reformation of the double emulsion droplets (e.g., W/O/W double emulsion droplets) after manipulating or modifying the single emulsion droplets, a junction 130 for introduction of an aqueous dispersing fluid may be positioned downstream of the manipulation portion 108 (which may include a fluorophilic and/or hydrophobic inner surface 118) and upstream of the reforming portion 110 (which may include a hydrophilic inner surface 120). The reforming portion 110 may have a geometry configured for reforming double emulsion droplets from the single emulsion droplets. In one example, the geometry may comprise a step change or gradient change in a dimension of the channel 102. For example, the channel 102 may increase in width and/or height from a constricted size over part or all of the manipulation portion 108 to a larger size in the reforming portion 110. The junction 130 for the introduction of the aqueous fluid may have a hydrophilic inner surface 120. An outlet 140 downstream of the reforming portion 110 may allow for collection of reformed double emulsion droplets.

The microfluidic device 100 may be made of and/or comprise a glass or a polymer, such as polydimethylsiloxane (PDMS), polymethylmethacrylate (PMMA), polycarbonate (PC), cyclic olefin copolymer (COC), or another polymer. The fluorophilic and/or hydrophobic inner surface(s) of the channel may be made of and/or comprise a fluorinated coating or functional groups, such as a fluoroalkylsilane (e.g., Aquapel®), optionally with a surfactant. The hydrophilic inner surface(s) of the channel may be made of and/or comprise a hydrophilic coating or functional groups, e.g., a polyelectrolyte such as polydiallyldimethylammonium chloride (pDADMAC) and/or polystyrene sulfonate (pSS). The hydrophilic inner surface(s) may be formed by (a) oxidation of the native surface (surface —OH groups), (b) silanization to apply hydrophilic groups or attach sites for polymerization of hydrophilic polymers, or (c) direct deposition of hydrophilic polymers, such as polyvinyl alcohol (PVA), polyethylene glycol (PEG), polydiallyldimethylammonium chloride/polystyrene sulfonate (pDADMAC(+)/pSS(−)), carboxybetaine (pCB), or polyacrylamide.

Now that features of the microfluidic device 100 have been described, a method for emulsion switching is discussed. The method comprises injecting double emulsion droplets into an inlet 104 of a channel 102, where the channel 102 may have any or all of the features described above or elsewhere in this disclosure. The double emulsion droplets may be introduced into the channel at an injection rate in a range from 1 μl/h to 1000 μl/h, or more typically from 10 μl/h to 30 μl/h. Once injected, the flow rate of the double emulsion droplets through the channel 102 may vary as the droplets are respaced and undergo emulsion switching, etc. The double emulsion droplets may comprise an aqueous core surrounded by an organic fluid shell suspended in a continuous aqueous fluid. The double emulsion droplets may be W/O/W double emulsion droplets. In other examples, as discussed in the aspects below, the double emulsion droplets may comprise an organic fluid core surrounded by an aqueous fluid shell suspended in a continuous organic fluid. Double emulsion droplets may be formed and stabilized using low-cost surfactants that ensure excellent drop stability when compared to single emulsions.

Downstream of the inlet 104, the double emulsion droplets are directly or indirectly converted into single emulsion droplets. Directly converting the double emulsion droplets into single emulsion droplets may comprise destabilizing the double emulsion droplets to form the single emulsion droplets. Indirectly converting the double emulsion droplets into single emulsion droplets may comprise first forming triple emulsion droplets from the double emulsion droplets and then destabilizing the triple emulsion droplets to obtain the single emulsion droplets. The triple emulsion droplets may be formed by introducing an organic spacing fluid into the channel 102 (e.g., via the junction 114), whereby the double emulsion droplets (e.g., W/O/W double emulsions) are respaced in the organic spacing fluid and a triple emulsion structure is created, e.g., water-in-oil-in-water-in-oil (W/O/W/O) triple emulsion droplets. Destabilization of the double or triple emulsion droplets may occur upon contact with an emulsion switching feature 106 (e.g., channel constriction 112, physical stimulus, chemical stimulus, and/or electrical stimulus) and/or a fluorophilic and/or hydrophobic inner surface 118 of the channel 102. During destabilization, the organic fluid (e.g., oil) shell coalesces with the organic spacing fluid and releases the aqueous core. After the emulsion switching feature 106 creates a flow of single emulsion droplets, which in some examples may be regularly spaced, the desired droplet modifications or manipulations may take place in the manipulation portion 108.

The single emulsion droplets may be manipulated and/or modified using existing or new on-chip modification methods, such as pico-injection, drop merging, drop splitting, and drop sorting. Pico-injection may comprise injecting an aqueous reagent fluid into the channel 102 for passive or active mixing with aqueous cores of the single emulsion droplets. The aqueous reagent fluid may be injected into the channel 102 prior to or after converting the double emulsion droplets into single emulsion droplets. Drop merging may comprise merging aqueous cores of the single emulsion droplets with aqueous cores of additional single emulsion droplets introduced into the channel 102 (e.g., through a junction 122). Drop splitting may comprise contacting the single emulsion droplets with a droplet splitter feature 126 of the channel 102, whereby the single emulsion droplets are split into first and second single emulsion droplets, which may in some examples have a predetermined volume ratio. The droplet splitter feature 126 (see FIG. 3) may comprise an upstream-facing apex at which the channel splits into first and second downstream branches 134a, 134b of smaller dimensions. The first single emulsion droplets may flow into the first downstream branch 134a and the second single emulsion droplets may flow into the second downstream branch 134b of the channel 102. Drop sorting may comprise screening the single emulsion droplets for a particular property or characteristic (see FIG. 4), and then sorting the single emulsion droplets into a downstream collection branch 144a and a downstream waste branch 144b of the channel 102 according to whether or not, respectively, they have the property or characteristic.

Double emulsion droplets may be reformed from the manipulated and/or modified single emulsion droplets and then removed through an outlet 140 of the device. The reforming or re-encapsulation step may be facilitated by introduction of an aqueous fluid (e.g., water and surfactant(s)) into the channel 102 at a location (e.g., the junction 130) downstream of the manipulation portion 108, and a switch in surface wetting from hydrophobic (in the manipulation portion 108) to hydrophilic (in the reforming portion 110).

The embodiment of the microfluidic device 100 shown in FIG. 1 takes double emulsions (e.g., W/O/W double emulsions) as an input and respaces them in oil. The outer aqueous shell that surrounds each DE drop is partitioned as a middle layer in the resulting triple emulsion. At the channel constriction 112, this triple emulsion is destabilized, releasing the aqueous core drop as a single emulsion W/O. A new fluid or liquid suspension is added to each of these aqueous cores in the manipulation portion 108, where one or more electrodes 132 may mediate fluid injection. The double emulsion is then reformed in the reforming portion 110 prior to collection. This device 100 enables an input DE to have reagents controllably added then collected as a double emulsion.

The embodiment of the microfluidic device 100 shown in FIG. 2 takes two populations of double emulsions and processes each of them as single emulsions on chip using emulsion switching. One aqueous core from each population is paired up and controllably merged, in this example at the one or more electrodes 132, to form a single combined drop in the manipulation portion 108. This droplet is then reformed as a double emulsion in the reforming portion 110. As an output this device 100 produces a single population of double emulsions with the merged contents of the original two drop populations as the aqueous core.

The embodiment of the microfluidic device 100 shown in FIG. 3 takes double emulsions as an input and processes them as single emulsions on chip using emulsion switching. The aqueous cores of the double emulsion are deterministically split in a given ratio using narrow branches 134a, 134b of predetermined dimensions (e.g., height and/or width). The double emulsions are then reformed producing as an output two or more populations of double emulsions containing a specific fraction of the aqueous contents of the original double emulsion.

The embodiment of the microfluidic device 100 shown in FIG. 4 takes double emulsions as an input and converts them to single emulsions on chip using emulsion switching. Some property of each droplet (absorbance, fluorescence, impedance, magnetization, etc.) is screened and used to activate a sorting function (electrodes that impart a dielectrophoretic force, a valve or pump that diverts flow into a specific channel, or other methods of active drop sorting) in the manipulation portion 108. FIG. 4 illustrates use of a laser 136 and fluorescence-activated sorting electrodes 138 to carry out the screening and sorting based on droplet fluorescence. Single emulsions can be obtained from either outlet 142.

The embodiment of the microfluidic device 100 shown in FIG. 5 takes double emulsions as an input and converts them to single emulsions on chip using emulsion switching. As before, each droplet is assayed and sorted into a designated channel 144a, 144b in the manipulation portion 108. The sorted aqueous cores can then be reformed into double emulsions in the reforming portion 110 and collected off chip. This may have the effect of sorting/enriching a rare desired droplet from a pool of many droplets.

The embodiment of the microfluidic device 100 shown in FIG. 6 respaces DE drops in a reagent fluid that contains contents that are to be added to each DE drop in the input. This double emulsion travels through the device 100 to a feature 106 that destabilized the oil shell. At a proximal location to the rupture of the DE, an oil stream is placed such that the mixed core and reagent are encapsulated into a single emulsion drop. The double emulsion is reformed from the reagent-added single emulsion drops.

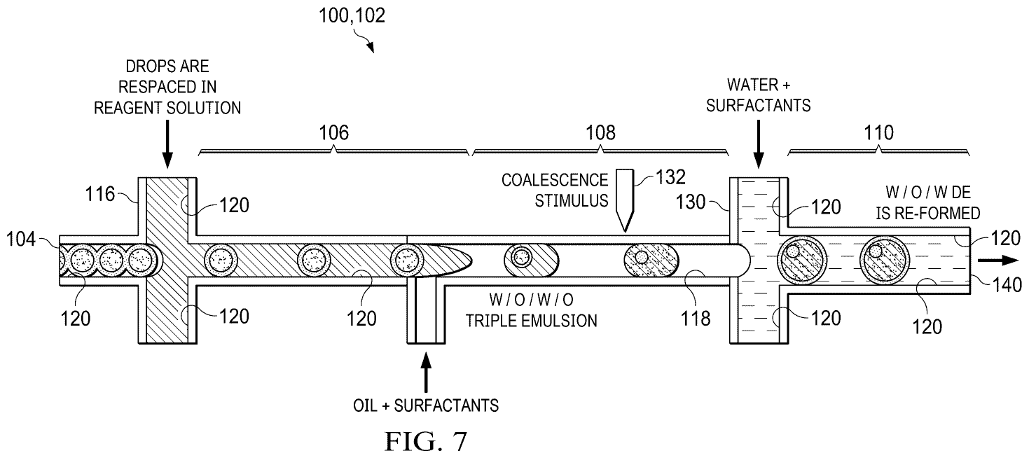

The embodiment of the microfluidic device 100 shown in FIG. 7 respaces DE drops in a reagent fluid that is to be added, similar to the embodiment of FIG. 6. Prior to destabilizing the double emulsion, it is first encapsulated in oil to form a W1/O/W2/O triple emulsion, where W1 represents the aqueous fluid of the core, and W2 represents the aqueous reagent fluid. A device feature such as one or more electrodes 132 induces coalescence of W1 and W2 which is later collected as a double emulsion.

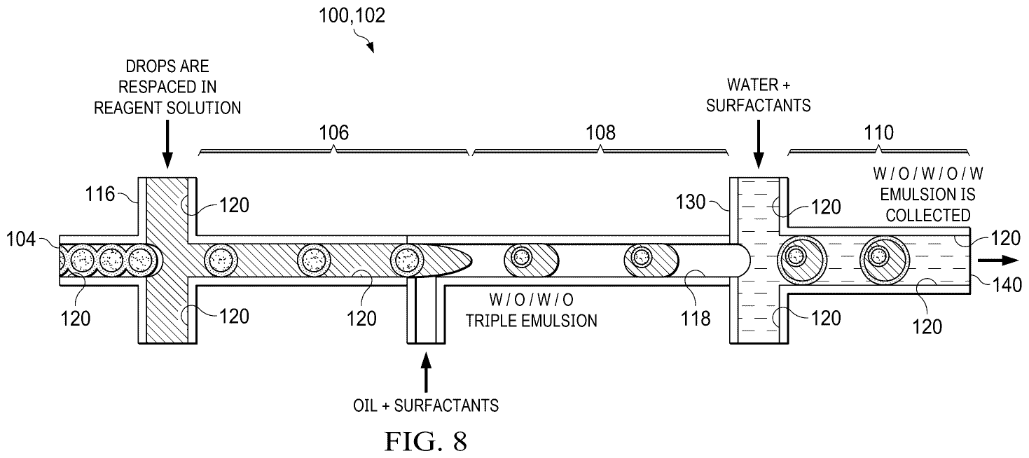

The embodiment of the microfluidic device 100 shown in FIG. 8 respaces DE drops in a reagent fluid that is to be added, similar to the embodiments of FIGS. 6 and 7. A triple emulsion including the DE input surrounded by a defined volume of a fluid to be added is generated by the device. This is collected in water following a final emulsification step. This DE in water in oil in water emulsion can be configured such that a surfactant in the reagent solution, an osmotic pressure, or other stimulus induces the inner DE to rupture and release its contents into the surrounded fluid. The cumulative effect is to add a reagent to a double emulsion.

The examples of the microfluidic device and method described above are directed to processing double emulsion droplets comprising an aqueous core surrounded by an organic fluid shell in a continuous aqueous fluid or phase (e.g., W/O/W double emulsions). However, as indicated above, the device and method are applicable also to processing double emulsion droplets comprising an organic fluid core surrounded by an aqueous shell in a continuous organic fluid or phase (e.g., O/W/O double emulsions). Accordingly, the microfluidic device and method may have alternative configurations and implementations as set forth in the aspects below.

### Examples

To illustrate drop-by-drop manipulation of double emulsion droplets (DEs), a microfluidic device designed to function as a double emulsion pico-injector was developed and used to perform a two-step reaction in double emulsions. The developed device acts equivalently to a single emulsion (SE) pico-injector, which takes a close-packed single emulsion and outputs a single emulsion with added reagents, by accepting as its input a close-packed double emulsion and outputting a double emulsion with added reagents.

To achieve this functionality, several advancements were made: (1) a method was developed to spatially co-pattern hydrophilic and fluorophilic surface coatings in PDMS/glass; (2) a device feature that converts DE drops to SE drops was introduced so that each core is accessible for on-chip manipulations, and 3) strategies to form high-quality DEs from irregular drop streams were formulated. Spatial patterning of hydrophilic and fluorophilic coatings enables one portion of the device to process single emulsions (fluorophilic) using existing drop-by-drop manipulations, while the other portion of the device makes double emulsions (hydrophilic) from the manipulated SE drops. The emulsion switching feature enables a respaced DE input to release the inner aqueous cores as water-in-oil SEs, which is the standard format accepted by existing pico-injector, drop merger, drop splitter, and drop sorter designs. The DE junction operates in a flow regime where the arrival of the core droplet triggers DE formation ensuring a high-quality DE is produced.

Using this microfluidic device, reagents were successfully added drop-by-drop to a double emulsion. In the first step, the double emulsion drops are injected and respaced in fluorinated oil. The resulting triple emulsion W/O/W/O (DE core in DE shell in outer aqueous phase in oil) is unstable under shearing in a constricted fluorophilic channel. As a result, the middle oil phase wets the surface, releasing the core of the DE as a W/O single emulsion droplet. The outer aqueous pocket is also released, but it is much smaller and does not disrupt the regular ordering provided by each DE core. This stream of now SE droplets can travel through the fluorophilic portion of the device and are manipulated using a pico-injector to add reagents to each. After the drop-by-drop manipulation is completed, the SE drops are broken up to reform the double emulsion in the hydrophilic portion of the device. Using these principles, DE microfluidics methods can be extended to encompass all existing SE techniques while retaining the advantages of increased stability and analysis.

### Methods

### Fabrication of the Microfluidic Device

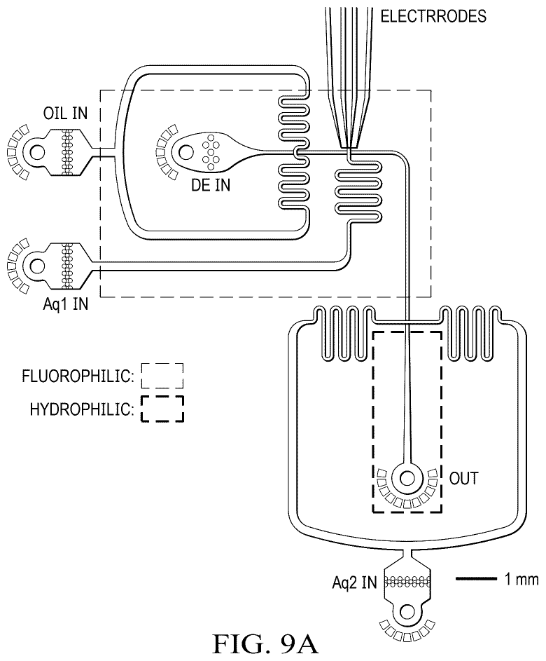

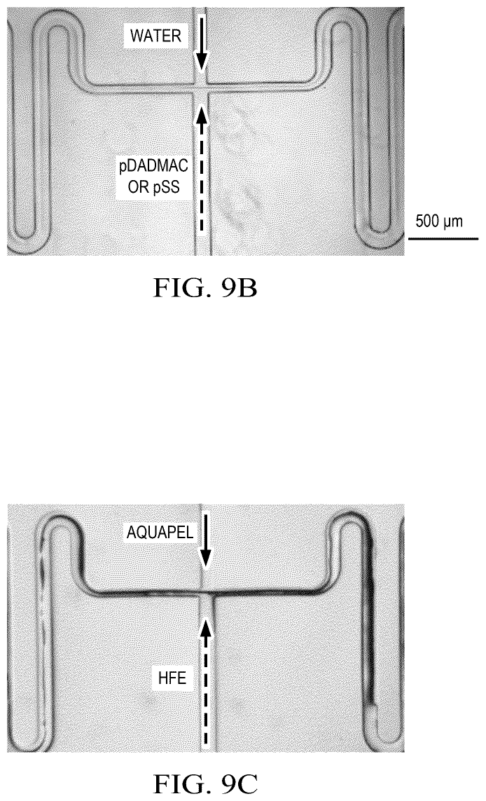

The microfluidic device, in this example a DE pico-injector, can be fabricated using established soft-lithography techniques. In the examples here, a single layer of photoresist (SU-8 2050) is spin-coated onto a 3-inch wafer to a height of 70 microns. Photo-lithography patterns the design (FIG. 9A) onto the wafer. After development, the device mold is then filled with PDMS, imprinting the channel designs into the polymer. The PDMS is cut from the wafer and bonded to glass using plasma treatment. The device is baked overnight to achieve robust bonding. Next, portions of the device are coated with polyelectrolyte solutions to deposit a strongly hydrophilic coating that facilitates DE drop formation (FIG. 9B). Following established methods, the outlet channel is activated by plasma treatment for 5 mins at 700 mTorr. The device is flushed with deionized (DI) water, which leaves negatively charged O— groups on the surfaces of the channels in the plasma-treated regions. A solution containing the cationic polymer polydiallyldimethylammonium chloride (PDMAC) is injected to the outlet where it deposits onto the negatively charged surface(s). Flow confinement limits the deposition to the desired portions of the device. The device is flushed to remove unbound polymers and the process is repeated with the anionic polymer polystyrene sulfonate (PSS), which deposits onto the cationic polymer, forming a strongly hydrophilic permanent surface coating. The device is flushed with water and dried to complete the hydrophilic coating. As shown in FIG. 9C, fluorophilic treatment is performed in a similar way using flow confinement to spatially control the application of a fluorophilic surface coating agent (e.g., a fluoroalkylsilane such as Aquapel®). The device is filled with hydrofluoroether (HFE-7500) injected from the outlet. The fluorophilic surface coating agent is then introduced from the drop inlet, where it fills all portions of the device except the downstream portions of the DE junction. After the surface coating agent is applied, the device is flushed with HFE and then dried to complete the fluorophilic coating. The resulting spatially patterned device has strongly fluorophilic portions needed for the conversion of DE drops to single emulsion (SE), manipulation of SE drops, and strongly hydrophilic portions needed for the conversion back to DE drops.

### Operation of the Microfluidic Device

Monodisperse DE drops (37/56 μm, core/shell) were prepared to include an aqueous core of 1 mg/mL dextran-TexasRed in a PCR buffer surrounded by an oil shell of 2% fluorosurfactant in HFE. These drops were collected as a pellet in the outer aqueous which consists of the PCR buffer and 1% tween-20 with 2% P-188. To reinject, a syringe with tubing was pre-filled with HFE. The tubing was placed within the DE pellet and the plunger was slowly withdrawn to draw the DE drops into the tubing. Syringes for respacing oil (2.2% krytox in HFE), the added reagent (PCR buffer with 2% BSA and 1 mg/mL dextran-FITC), and outer aqueous were also prepared. Syringes were loaded into pumps and connected to the device. Injection to the device was stabilized at a flow rate of 20|10|70|500, DE|aq1|oil|aq2. Stable pico-injection was achieved with an applied AC voltage of ˜1 kV and DE drops were collected.

Two-Step Expression of an Aptamer Pool by Double Emulsion ddPCR/T7

DNA oligos encoding the broccoli aptamer pool sequences were ordered from IDT. Monodisperse DE droplets were prepared for ddPCR amplification of the aptamer pool at 25|55|300 μL/h aq1|oil|OA. Aq1 was composed of 1× Platinum II pcr mix (Thermo) with 1 μm each forward and reverse primers, and the aptamer pool along with the broccoli sequence spiked in a rate of ˜1 in 5000. The oil phase included 2 w % RAN flourosurfactant in HFE. The outer aqueous phase included PCR buffer components; 20 mM tris, 50 mM KCl, 1.5 mM MgCl2, and added surfactants; 1% tween-20, 2% P-188. The resulting DE drops had an average core/shell diameter of 46/63 μm. The emulsion was thermocycled, 86 C, 3 min; 50 cycles: (86 C, 30 s; 52 C, 15 s; 68 C, 30 s); 68 C, 2 min; 20 C end, to produce DNA amplicons in each occupied drop. After PCR amplification, the emulsion was slowly drawn into a pre-filled syringe tubing backed with HFE oil. Syringes were also prepared for injection of 2.2% ionic krytox in HFE (oil) and 1.5× T7 reagent kit (NEB) with 3% BSA (aq1). The outer aqueous phase again consisted of PCR buffer components with added surfactants, as this facilitated efficient DE generation which was not possible using T7 buffer as the outer aqueous phase. After the reagents were added to the double emulsion drops, the DE pellet was transferred to T7 OA consisting of 1× T7 buffer with 1% tween-20, 2% P-188. Although this buffer was not suitable for drop generation likely due to its lower ionic strength, it is needed for efficient RNA synthesis during the overnight incubation at 37 C. Following RNA synthesis in drops, the emulsion was transferred to T7 OA with 5 μM DFHBI for post staining of the droplets with the target dye for the broccoli aptamer.

### Wolf Sorting Protocol

The sorted and unsorted DE pellets were carefully transferred to clean tubes with ˜50 μL of 20% PFO in HFE for de-emulsification. The aqueous phase was transferred into a PCR mix to further amplify the recovered DNA sequences. The PCR mix was the same as before, but with 5 μL of the recovered aqueous phase in each 50 μL reaction. The product was PCR purified and transferred to a T7 reaction to prepare fresh RNA. The RNA products were purified and quantified using Qubit SSRNA HS kit. 100 ng of RNA from each of the sorted and unsorted pools were added to 5 μM DFHBI in T7 OA and measured using a fluorimeter.

### Results

### On-Chip Emulsion Switching

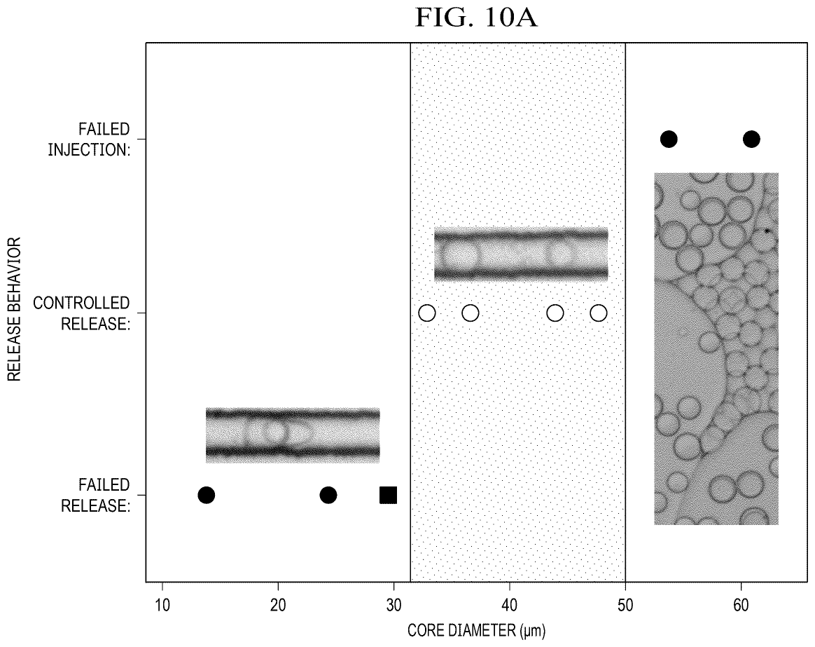

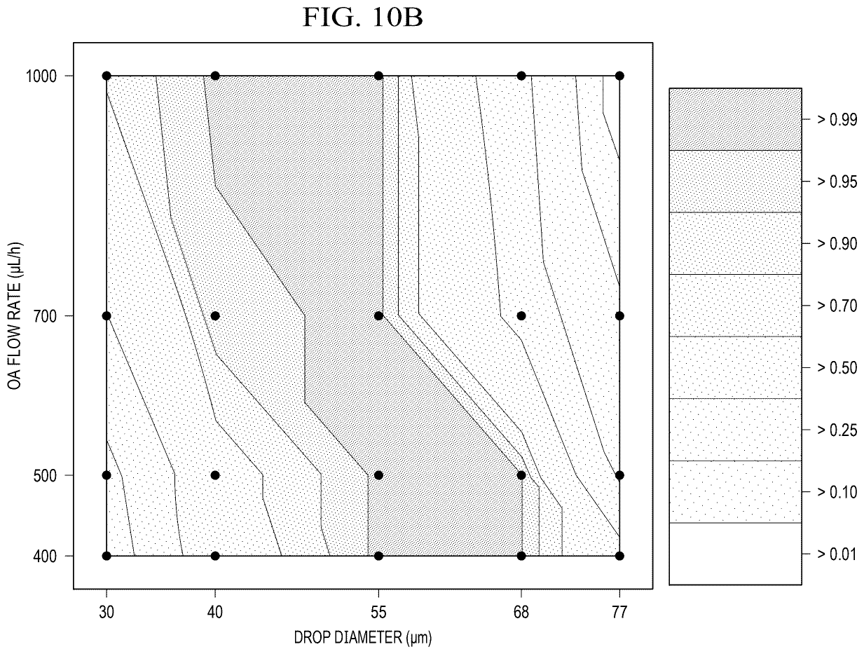

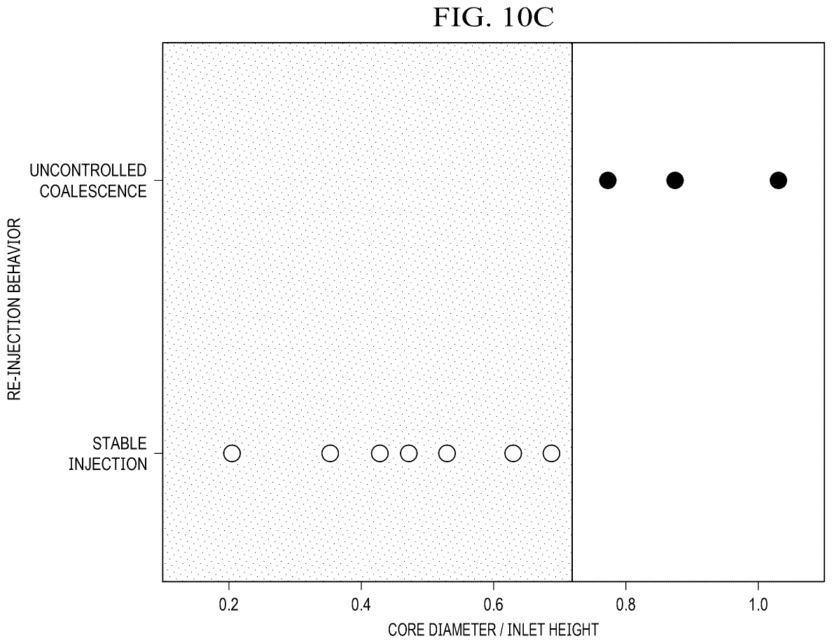

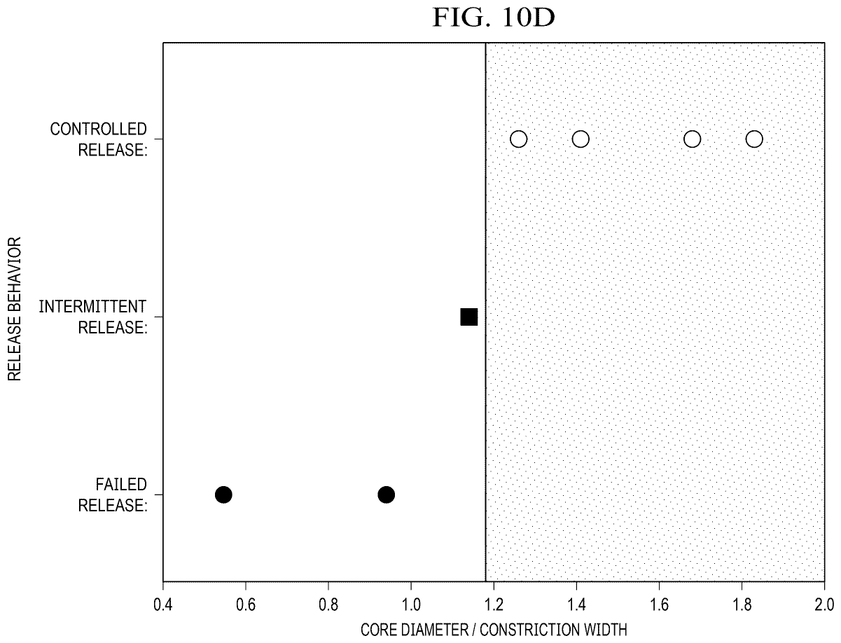

In order to perform drop-by-drop manipulations on double emulsions, the drops are first injected to the device, and respaced so that each droplet is spatially separated during de-wetting and release of the aqueous core. This ensures that undesirable coalescence is avoided during the conversion step. It was found that double emulsion drop injection is not strongly dependent on the surface wetting properties of the inlet as long as the device height is sufficiently greater than the drop size. When the input DE size is too large (>50 μm cores), the emulsion fails to inject without merging (FIG. 10A). Uncontrolled core-release occurs at the inlet and drops are able to merge with each other and the outer aqueous as they are forced into contact with the walls of the device. At drop sizes well below that of the device height, DEs can be reinjected stably into an aquapelled device. This eliminates the need for a third surface treatment step that would be needed to apply a hydrophilic coat at the inlet. Within the range from 30-50 μm, DE drops are correctly sized for the microfluidic device of this example and will undergo controlled release within the constricted channel of the device (FIG. 10A). Around 30 μm, the core release process becomes unreliable. These drops may release intermittently, many drops passing through the entire length of the constriction without bursting. Below this size (>30 μm) the DE drops may pass through the channel entirely without releasing their inner cores. To successfully process DE of other sizes, the device dimensions may be re-scaled. Referring to FIG. 10C, the size of the various DE inputs may be expressed as the ratio of the DE core diameter to the inlet height. For core diameters less than 70% of the inlet height, the DEs remained stable during reinjection. Above this critical size, the confinement forces are sufficient to overcome the disjoining pressure causing uncontrolled coalescence of the various phases. To facilitate the reinjection of larger-sized DEs, an additional hydrophilic surface treatment may be applied to the inlet, or a multi-layer device may be used so that the inlet height is greater than the remainder of the device. A single-layer design keeps the device complexity low while accommodating a large range of DE inputs.

Following reinjection and respacing, the next step makes the inner aqueous compartment of each drop accessible for manipulation (e.g., picoinjection). This may be achieved using a constricted channel that reliably releases cores by rupturing each respaced DE. The fluorophilic channel surface ensures that aqueous components remain as drops in oil and do not contaminate the channel during DE to SE conversion. To characterize the range of suitable sizes for core release in this device, various DE inputs were screened, as shown in FIG. 10D. The input drop sizes are expressed as a ratio of the DE core diameter to the constricted channel width. The fluorophilic channels of the device are preferentially wetted by the oil shell of the DE. However, the shell is separated from the surface by the residual OA material that now forms an aqueous shell of the triple emulsion. When these drops are forced into greater confinement in the constricted channel, the disjoining pressure of the OA shell can be overcome allowing the oil shell to coalesce with the continuous oil phase. Since the constriction is of a constant size, larger DEs are subjected to greater confinement forces which ensure coalescence.

As described in the previous section, the inlet height during reinjection constrains the maximum size of DE inputs for this device to ˜2 times the constriction width. DEs above this size would likely release in the constriction but could not be tested as they coalesce in the inlet during reinjection. Between this upper limit and ˜1.2 times the constricted channel, DEs may be reliably converted to SEs, as shown in FIG. 10D. During controlled core release in the constricted channel, the OA shell is thinned until the oil phases coalesce. Given the configuration of the aqueous phases in the instant prior to oil-phase coalescence, the inner aqueous phase remains as a single independent drop while the OA shell material rapidly collapses to minimize the surface area. This results in a primary OA drop and one or more satellite drops that do not readily combine due to the presence of surfactants. This controlled core release process results in quantitative conversion of each DE in the input converting to a SE that is accessible for manipulation (e.g., picoinjection).

As the size of the DE input is decreased further (˜1.1), the emulsion switching process becomes unreliable, and not all DE cores are released (see FIG. 10D). Below this size, the emulsion fails to release any cores as it passes through the constricted channel. By first encapsulating the DE as a triple emulsion it is possible to ensure that the inner compartment remains shielded from the outer aqueous phase during coalescence such that the aqueous core is released intact. A large range of suitable DE inputs have been identified that can be controllably converted drop-by-drop to an accessible SE format. The design of the inlet and constricted channel may be rescaled to accommodate DEs of other size ranges.

DE Formation from Irregular Inputs

This device is able to produce a high-quality DE output by utilizing the aqueous core to trigger droplet pinch off. This may be critical to ensuring that the potentially irregular stream of drops that are produced during pico-injection are successfully partitioned into separate drops with minimal splitting. The resulting DE quality may depend on a variety of factors. The device height was chosen to ensure successfully re-injection and core-release and so cannot be changed at the DE junction without adding further fabrication steps. This leaves the junction width and the OA flow-rate as the primary handles to control DE drop formation. The DE junction width was varied during development but set to be 60 μm as this resulted in smaller overall DE sizes without significant core-splitting. To assess the operational range of this device, a range of input drop sizes were screened using the OA to tune DE formation and characterized the quality of the DE output. In general, the output of this device is an emulsion in water. As the device operates it will continuously produce O/W drops at the hydrophilic junction, but these do not impact reactions in DE drops and can be readily separated from the desired DE population based on density. Accordingly, the size and frequency of excess oil drops is ignored in an assessment of DE quality. Instead, high-quality DEs include those drops that encapsulate aqueous cores alone and, in their entirety, to form a single-core DE drop. From this systematic screening of device parameters (FIG. 10B), various failure modes were identified and the regime of successful double emulsification was mapped. At low drop sizes >40 μm, multi-core DEs are readily produced. Increasing the OA flow rate may reduce the number of cores per drop but the flow will begin to jet long before all DEs are partitioned with single cores. Between 40 and 68 μm, stable pinch-off is controlled by the OA flow rate and can be optimized to produce high-quality DEs. Above this drop size, aqueous cores do not easily fit within a single DE drop and are split into pieces even at the lowest OA flow rates. Further reductions in OA flow resulted in the oil-phase jetting that was unsuitable for drop formation. Beyond achieving a single-core loading it is also desirable that the resulting DE is monodisperse and relatively thin-shelled. This keeps the total drop size and density at a minimum, which improves FACS detection. Using this confined channel geometry, on-chip oil-shearing is facilitated which improves the size distribution of the shell. Although the optimal range of flow rates and droplet sizes for this device is fixed, modification of the device design can accommodate DE inputs of other sizes.

### Reagent Addition to DE Cores

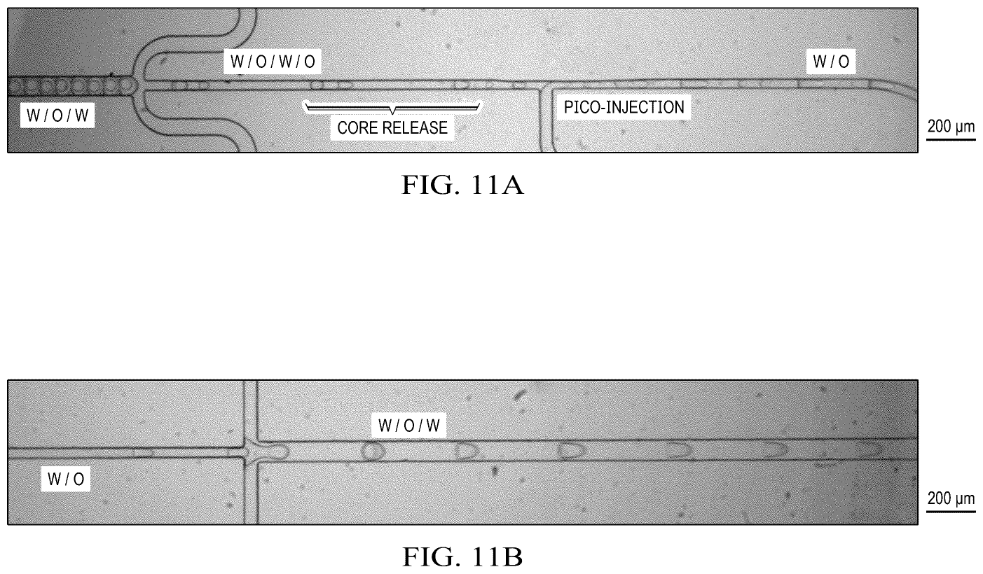

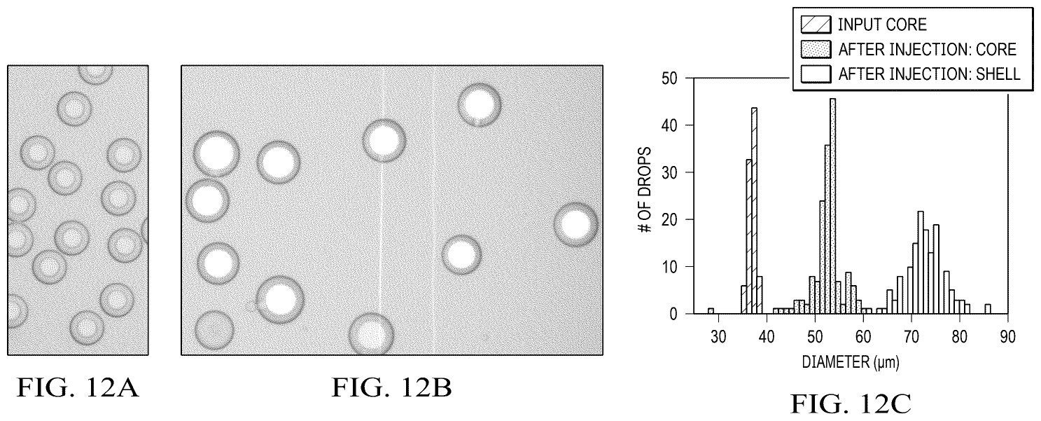

To demonstrate the combined operation of these features, reagent addition to a double emulsion was carried out. Each fluid component was tracked throughout the process, by labeling with fluorescent dyes. The cores of the input DE were labeled with a red-fluorescent dye, while the pico-injection reagent was labeled with a green-fluorescent dye. The oil and outer aqueous were not fluorescent but can be readily distinguished as the unlabeled portions of the final emulsion. FIGS. 11A and 11B show the full device during operation for pico-injection to the released cores of a double emulsion. Importantly, the surface treatment strategy enables the device to first release the cores of the double emulsion, process them as a single emulsion (FIG. 11A), then reliably re-encapsulate the injected cores to re-form a double emulsion (FIG. 11B). The stream of droplets produced by the pico-injector are successfully loaded into single core DEs at the hydrophilic junction. The result of this sequence of operations is to controllably add reagents to each core of a double emulsion with a narrowly distributed total size and a high fraction of single-core droplets. By ensuring that each pico-injected core contributes a significant fraction of the minimum drop volume (>40%) needed for pinch-off, drop generation is effectively triggered by the arrival of the aqueous core at the junction. This enables a significant improvement in the monodispersity of the resulting double emulsion compared to a case where the core arrivals do not substantially impact the formation of the outer drop. Additionally, two-core drops are largely avoided in this flow regime. This enables the device to accommodate the relative heterogeneity in the stream of SE drops that results from the core release process and subsequent pico-injection. At this optimized condition, the input drops (FIG. 12A) are injected with new reagents one-by-one to produce the output drops (FIG. 12B) where the new double emulsion has reagents added to each drop. The size histogram (FIG. 12C) illustrates the high quality of the resulting double emulsion. The input DE is highly monodisperse with each core containing ˜25 pL. Following pico-injection and re-encapsulation, the new DE cores contain ˜75 pL and are monodisperse to within 10% (n≈300). This 2:1 mixing ratio is typical of a pico-injector of this type and could be modified to achieve other mixing ratios like a standard SE-pico injector. Importantly, each DE was successfully delivered with a controlled volume of new reagents illustrating the potential of this microfluidic approach to enable multi-step reactions in DE drops.

Double Emulsion ddPCR Followed by Reagent Addition for Droplet Digital T7 RNA Synthesis of an Aptamer Library:

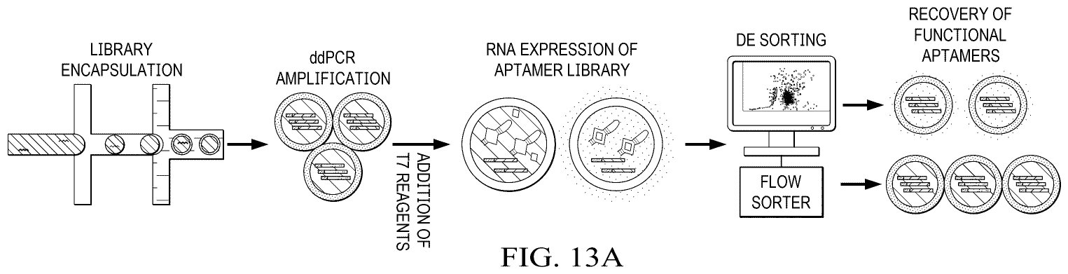

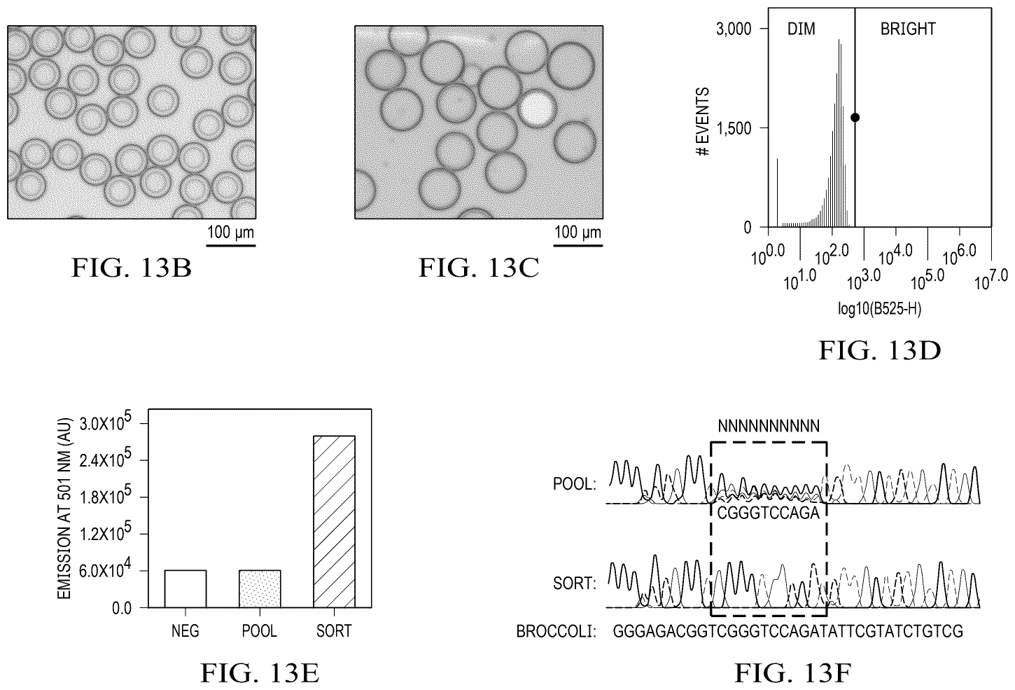

Now that it is possible to controllably add reagents to a double emulsion, two sequential molecular biology reactions were performed in DE droplets to screen an RNA aptamer pool to identify and recover those that produce significant light-up fluorescence in the presence of the target dye. As shown in FIG. 13A, an initial double emulsion is formed for digital amplification of a pool of DNA sequences encoding a library of RNA aptamers. Since a single DNA copy is insufficient for high yield RNA synthesis by the T7 polymerase, direct encapsulation of the DNA pool is not effective for aptamer screening. Instead, PCR amplification generates a large pool of amplicons in each drop with a template. FIG. 13B shows the DE droplets that encapsulate the aptamer pool. The broccoli sequence was modified to contain 10 consecutive random bases around the binding region of the target dye. This results in 10⁶ unique sequences. Although it might be possible to screen a pool of this size, it is impractical in this case. Accordingly, the correct broccoli sequence was added to the pool at a rate of approximately 1 in 5000 templates. These drops were thermocycled to generate PCR amplicons, then reinjected and processed as described previously to add T7 reagents to each droplet core and reform the double emulsion after reagent addition. The drops were transferred into an outer aqueous phase containing the T7 buffer and incubated overnight to achieve RNA synthesis. In the presence of 5 μM DFHBI, the drops that contain the correct aptamer sequence display significantly increased green-fluorescence (FIG. 13C). Using a low-pressure flow-sorter (WOLF G2) with relatively large channel dimensions, DE droplets as large as 70-80 μm can be detected and sorted. The pool of RNA aptamer droplets was screened and sorted to recover the droplets with the highest green-fluorescent signals (FIG. 13D). The DNA amplicons from these drops were recovered and compared against those from the unsorted pool. Following PCR amplification of the sort outputs, DNA was purified and used for RNA synthesis in bulk to generate aptamers at high yield. The sorted and unsorted RNA aptamers were purified and quantified so that an equal concentration of each could be compared. The sorted pool displayed almost 10-fold higher fluorescence emission at 501 nm when compared to the unsorted pool. FIG. 13F shows Sanger sequencing results from the aptamer screen, where sorting recovers the correct broccoli sequence. This successfully demonstrates the potential of DE manipulations to achieve multi-step workflows in DE drops.

The subject matter if this disclosure also includes the following aspects:

A first aspect relates to a microfluidic device for emulsion switching, the microfluidic device comprising: a channel comprising: an inlet for injection of double emulsion droplets; an emulsion switching feature downstream of the inlet for converting the double emulsion droplets directly or indirectly into single emulsion droplets; a manipulation portion downstream of the emulsion switching feature for manipulating and/or modifying the single emulsion droplets, the manipulation portion including a non-wetting inner surface configured to avoid wetting of the single emulsion droplets; and a reforming portion downstream of the manipulation portion.

A second aspect relates to the microfluidic device of the preceding aspect, wherein the non-wetting inner surface comprises a fluorophilic inner surface and/or a hydrophobic inner surface.

A third aspect relates to the microfluidic device of any preceding aspect, wherein the non-wetting inner surface comprises a hydrophilic inner surface.

A fourth aspect relates to the microfluidic device of any preceding aspect, wherein the emulsion switching feature comprises any feature or stimulus capable of destabilizing the double emulsion droplets such that the inner core is released from the surrounding shell as a single emulsion, such as a physical stimulus, a chemical stimulus, an electrical stimulus, and/or a channel constriction.

A fifth aspect relates to the microfluidic device of the preceding aspect, wherein the channel constriction extends downstream along part or all of the manipulation portion of the channel.

A sixth aspect relates to the microfluidic device of any preceding aspect, wherein the channel further comprises, downstream of the inlet and upstream of the emulsion switching feature, a junction for introduction of a spacing fluid.

A seventh aspect relates to the microfluidic device of the preceding aspect, wherein the spacing fluid is immiscible with a continuous phase of the double emulsion droplets.

An eighth aspect relates to the microfluidic device of any preceding aspect, wherein the spacing fluid is miscible with a continuous phase of the double emulsion droplets.

A ninth aspect relates to the microfluidic device of any preceding aspect, wherein the spacing fluid comprises an aqueous spacing fluid.

A tenth aspect relates to the microfluidic device of any preceding aspect, wherein the spacing fluid comprises an organic spacing fluid.

An eleventh aspect relates to the microfluidic device of any preceding aspect, wherein the inlet of the channel comprises a hydrophobic inner surface and/or a fluorophilic inner surface.

A twelfth aspect relates to the microfluidic device of any preceding aspect, wherein the inlet of the channel comprises a hydrophilic inner surface.

A thirteenth aspect relates to the microfluidic device of any preceding aspect, wherein the channel further comprises, downstream of the inlet and upstream of the emulsion switching feature, a junction for introduction of a reagent fluid to be added to the single emulsion droplets.

A fourteenth aspect relates to the microfluidic device of any preceding aspect, wherein the manipulation portion is configured to implement drop-by-drop manipulation techniques selected from the group consisting of pico-injection, drop merging, drop splitting, drop sorting, content extraction from drops, and others.

A fifteenth aspect relates to the microfluidic device of any preceding aspect, wherein the channel further comprises, positioned within the manipulation portion, a junction for introduction of an additional population of single emulsion droplets for drop merging.

A sixteenth aspect relates to the microfluidic device of the preceding aspect, wherein the additional population of single emulsion droplets include single emulsion droplets released from emulsion switching of double emulsion droplets.

A seventeenth aspect relates to the microfluidic device of any preceding aspect, wherein the channel further comprises, positioned within the manipulation portion, a junction for introduction of a reagent fluid to be added to the single emulsion droplets.

An eighteenth aspect relates to the microfluidic device of any preceding aspect, wherein the channel further comprises, positioned within the manipulation portion, two or more downstream branches.

A nineteenth aspect relates to the microfluidic device of the preceding aspect, wherein at least one of the two or more downstream branches terminates in the reforming portion.

A twentieth aspect relates to the microfluidic device of any preceding aspect, wherein the channel includes a drop splitting feature immediately upstream of the two or more downstream branches.

A twenty-first aspect relates to the microfluidic device of any preceding aspect, wherein the channel includes a screening and sorting device immediately upstream of the two or more downstream branches.

A twenty-second aspect relates to the microfluidic device of any preceding aspect, wherein the channel further comprises, downstream of the manipulation portion and immediately upstream of the reforming portion, a junction for introduction of a dispersing fluid for reforming double emulsion droplets from the single emulsion droplets.

A twenty-third aspect relates to the microfluidic device of any preceding aspect, wherein the reforming portion includes a hydrophilic inner surface for reforming double emulsion droplets from the single emulsion droplets.

A twenty-fourth aspect relates to the microfluidic device of any preceding aspect, wherein the reforming portion includes a fluorophilic and/or a hydrophobic inner surface for reforming double emulsion droplets from the single emulsion droplets.

A twenty-fifth aspect relates to the microfluidic device of any preceding aspect, wherein the reforming portion is configured to produce a surface wetting change for reforming double emulsion droplets from the single emulsion droplets.

A twenty-sixth aspect relates to the microfluidic device of any preceding aspect, wherein the reforming portion includes a geometry configured for reforming double emulsion droplets from the single emulsion droplets.

A twenty-seventh aspect relates to the microfluidic device of the preceding aspect, wherein the geometry comprises a step change or gradient change in a dimension of the channel.

A twenty-eighth aspect relates to the microfluidic device of any preceding aspect, wherein the channel further comprises an outlet downstream of the reforming portion for collection of reformed double emulsion droplets.

A twenty-ninth aspect relates to the microfluidic device of any preceding aspect, wherein the hydrophilic inner surface of any portion of the channel includes a hydrophilic coating or functional group.

A thirtieth aspect relates to the microfluidic device of the preceding aspect, wherein the hydrophilic coating or functional group comprises a hydroxyl (—OH) group from oxidation of the surface or a hydrophilic group or polymer attached by silanization or deposition.

A thirty-first aspect relates to the microfluidic device of the preceding aspect, wherein the hydrophilic polymer is selected from the group consisting of: polyvinyl alcohol (PVA), polyethylene glycol (PEG), polydiallyldimethylammonium chloride/polystyrene sulfonate (pDADMAC(+)/pSS(−)), carboxybetaine (pCB), or polyacrylamide.

A thirty-second aspect relates to the microfluidic device of any preceding aspect, wherein the fluorophilic inner surface of any portion of the channel includes a fluorophilic or fluorinated coating or functional group, and/or wherein the hydrophobic inner surface of any portion of the channel includes a hydrophobic coating or functional group.

A thirty-third aspect relates to the microfluidic device of the preceding aspect, wherein the fluorinated coating or functional group comprises a fluoroalkylsilane.

A thirty-fourth aspect relates to the microfluidic device of any preceding aspect, wherein the reagent or spacing fluid comprises cell culture media and buffer(s), molecular biology reagent(s) and buffer(s), water-soluble monomer(s), polymer(s) or pre-polymer(s), and/or another aqueous phase system.

A thirty-fifth aspect relates to the microfluidic device of any preceding aspect, wherein the channel comprises a glass, a polymer, a metal, or another material.

A thirty-sixth aspect relates to a method for emulsion switching, the method comprising: injecting double emulsion droplets into an inlet of a channel, the double emulsion droplets flowing downstream in the channel; converting the double emulsion droplets directly or indirectly into single emulsion droplets, the single emulsion droplets continuing to flow downstream in the channel; manipulating and/or modifying the single emulsion droplets in a spacing fluid during the flow downstream; after the manipulation and/or modification, reforming double emulsion droplets from the single emulsion droplets in a dispersing fluid, the reformed double emulsion droplets continuing to flow downstream in the channel; and collecting the reformed double emulsion droplets from an outlet of the channel.

A thirty-seventh aspect relates to the method of the preceding aspect, wherein the double emulsion droplets are injected into the inlet of the channel at a predetermined flow rate.

A thirty-eighth aspect relates to the method of the preceding aspect, the predetermined flow rate is in a range from 1 μl/h to 5000 μl/h.

A thirty-ninth aspect relates to the method of any preceding aspect, wherein the double emulsion droplets comprise a core surrounded by an immiscible fluid shell suspended in a continuous fluid, immiscible with the shell.

A fortieth aspect relates to the method of any preceding aspect, wherein the double emulsion droplets include water-in-oil-in-water (W/O/W) double emulsion droplets.

A forty-first aspect relates to the method of any preceding aspect, wherein the double emulsion droplets include oil-in-water-in-oil (O/W/O) double emulsion droplets.

A forty-second aspect relates to the method of any preceding aspect, wherein directly converting the double emulsion droplets into single emulsion droplets comprises: destabilizing the double emulsion droplets to form the single emulsion droplets.

A forty-third aspect relates to the method of the preceding aspect, further comprising, after destabilizing the double emulsion droplets, dispersing the single emulsion droplets in the spacing fluid.

A forty-fourth aspect relates to the method of any preceding aspect, wherein destabilization of the double emulsion droplets is initiated upon contact with an emulsion switching feature of the channel, wherein the emulsion switching feature may comprise, in some examples, a physical stimulus, a chemical stimulus, an electrical stimulus, and/or a channel constriction.

A forty-fifth aspect relates to the method of any preceding aspect, wherein indirectly converting the double emulsion droplets into single emulsion droplets comprises: forming triple emulsion droplets from the double emulsion droplets; and destabilizing the triple emulsion droplets to obtain the single emulsion droplets.

A forty-sixth aspect relates to the method of any preceding aspect, wherein forming the triple emulsion droplets comprises dispersing the double emulsion droplets in the spacing fluid.

A forty-seventh aspect relates to the method of any preceding aspect, wherein destabilization of the triple emulsion droplets is initiated upon contact with an emulsion switching feature of the channel, wherein the emulsion switching feature may comprise, in some examples, a physical stimulus, a chemical stimulus, an electrical stimulus, and/or a channel constriction.

A forty-eighth aspect relates to the method of any preceding aspect, wherein manipulating and/or modifying the single emulsion droplets comprises pico-injection, drop merging, drop splitting, drop sorting, and/or content extraction from drops.

A forty-ninth aspect relates to the method of the preceding aspect, wherein the pico-injection comprises injecting a reagent fluid into the channel for passive or active addition to the single emulsion droplets.

A fiftieth aspect relates to the method of any preceding aspect, wherein the reagent fluid is injected into the channel prior to converting the double emulsion droplets into single emulsion droplets.

A fifty-first aspect relates to the method of any preceding aspect, wherein the reagent fluid is injected into the channel after converting the double emulsion droplets into single emulsion droplets.

A fifty-second aspect relates to the method of any preceding aspect, wherein the drop merging comprises merging aqueous cores of the single emulsion droplets with aqueous cores of additional single emulsion droplets introduced into the channel.

A fifty-third aspect relates to the method of any preceding aspect, wherein the drop splitting comprises contacting the single emulsion droplets with a droplet splitter feature of the channel, whereby the single emulsion droplets are split into multiple single emulsion droplets.

A fifty-fourth aspect relates to the method of the preceding aspect, the multiple single emulsion droplets have a predetermined volume ratio.

A fifty-fifth aspect relates to the method of any preceding aspect, wherein each of the multiple single emulsion droplets flows into a different downstream branch of the channel.

A fifty-sixth aspect relates to the method of any preceding aspect, wherein the drop sorting comprises screening the single emulsion droplets for a specified property and sorting the single emulsion droplets having the specified property into a downstream collection branch of the channel and those not having the specified property into a downstream waste branch of the channel.

A fifty-seventh aspect relates to the method of any preceding aspect, wherein reforming the double emulsion droplets comprises: introducing the dispersing fluid into the channel at a location downstream of where the single emulsion droplets are manipulated and/or modified, the single emulsion droplets being carried downstream by the spacing fluid into the dispersing fluid; and after entry into the dispersing fluid, exposing the single emulsion droplets to an inner surface of the channel configured to be non-wetting to the spacing fluid, and/or to a geometry configured for reforming double emulsion droplets from the single emulsion droplets.

A fifty-eighth aspect relates to the method of any preceding aspect, wherein the inner surface of the channel configured to be non-wetting to the spacing fluid comprises a hydrophobic and/or a fluorophilic inner surface.

A fifty-ninth aspect relates to the method of any preceding aspect, wherein the inner surface of the channel configured to be non-wetting to the spacing fluid comprises a hydrophilic inner surface.

A sixtieth aspect relates to the method of any preceding aspect, wherein the dispersing fluid is immiscible with the spacing fluid.

A sixty-first aspect relates to the method of any preceding aspect, wherein the geometry comprises a step change in a dimension of the channel.

A sixty-second aspect relates to the method of any preceding aspect, wherein the spacing fluid introduced into the channel comprises a fluorinated organic compound, such as hydrofluoroether containing a fluorosurfactant.

A sixty-third aspect relates to the method of any preceding aspect, wherein the spacing or reagent fluid introduced into the channel comprises cell culture media and buffer(s), molecular biology reagent(s) and buffer(s), water-soluble monomer(s), polymer(s) or pre-polymer(s), and/or another aqueous phase system.

A sixty-fourth aspect relates to the method of any preceding aspect, wherein the channel comprises: the inlet; an emulsion switching feature downstream of the inlet; a manipulation portion including a fluorophilic and/or hydrophobic inner surface downstream of the emulsion switching feature; and a reforming portion including a hydrophilic inner surface downstream of the manipulation portion.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A microfluidic device for emulsion switching, the microfluidic device comprising:
a channel comprising:
an inlet for injection of double emulsion droplets;
an emulsion switching feature downstream of the inlet for converting the double emulsion droplets directly or indirectly into single emulsion droplets;
a manipulation portion downstream of the emulsion switching feature for manipulating and/or modifying the single emulsion droplets, the manipulation portion including a non-wetting inner surface configured to avoid wetting of the single emulsion droplets; and
a reforming portion downstream of the manipulation portion.

2. The microfluidic device of claim 1, wherein the emulsion switching feature comprises a channel constriction, an electrical stimulus, a chemical stimulus and/or a physical stimulus.

3. The microfluidic device of claim 1, wherein the channel further comprises, downstream of the inlet and upstream of the emulsion switching feature, a junction for introduction of a spacing fluid or a reagent fluid.

4. The microfluidic device of claim 1, wherein the manipulation portion is configured to implement drop-by-drop manipulation techniques selected from the group consisting of pico-injection, drop merging, drop splitting, drop sorting, and/or content extraction from drops.

5. The microfluidic device of claim 1, wherein the channel further comprises, positioned within the manipulation portion, a junction for introduction of a reagent fluid or an additional population of single emulsion droplets.

6. The microfluidic device of claim 1, wherein the channel further comprises, positioned within the manipulation portion, two or more downstream branches.

7. The microfluidic device of claim 6, wherein the channel includes a screening and sorting device immediately upstream of the two or more downstream branches.

8. The microfluidic device of claim 1, wherein the channel further comprises, downstream of the manipulation portion and immediately upstream of the reforming portion, a junction for introduction of a dispersing fluid for reforming double emulsion droplets from the single emulsion droplets.

9. The microfluidic device of claim 1, wherein the reforming portion is configured to produce a surface wetting change for reforming double emulsion droplets from the single emulsion droplets.

10. The microfluidic device of claim 1, wherein the reforming portion includes a geometry configured for reforming double emulsion droplets from the single emulsion droplets.

11. The microfluidic device of claim 10, wherein the geometry comprises a step change or gradient change in a dimension of the channel.

12. A method for emulsion switching, the method comprising:
injecting double emulsion droplets into an inlet of a channel, the double emulsion droplets flowing downstream in the channel;
converting the double emulsion droplets directly or indirectly into single emulsion droplets, the single emulsion droplets continuing to flow downstream in the channel;
manipulating and/or modifying the single emulsion droplets in a spacing fluid during the flow downstream;
after the manipulation and/or modification, reforming double emulsion droplets from the single emulsion droplets in a dispersing fluid, the reformed double emulsion droplets continuing to flow downstream in the channel; and
collecting the reformed double emulsion droplets from an outlet of the channel.

13. The method of claim 12, wherein the double emulsion droplets comprise an aqueous core surrounded by an organic fluid shell suspended in a continuous aqueous fluid.

14. The method of claim 12, wherein the double emulsion droplets comprise an organic fluid core surrounded by an aqueous shell suspended in a continuous organic fluid.

15. The method of claim 12, wherein directly converting the double emulsion droplets into single emulsion droplets comprises:
destabilizing the double emulsion droplets to form the single emulsion droplets, wherein the destabilization is initiated upon contact of the double emulsion droplets with an emulsion switching feature of the channel.

16. The method of claim 12, wherein indirectly converting the double emulsion droplets into single emulsion droplets comprises:
forming triple emulsion droplets from the double emulsion droplets; and
destabilizing the triple emulsion droplets to obtain the single emulsion droplets, wherein the destabilization is initiated upon contact of the triple emulsion droplets with an emulsion switching feature of the channel.

17. The method of claim 12, wherein manipulating and/or modifying the single emulsion droplets comprises pico-injection, drop merging, drop splitting, drop sorting, and/or content extraction from drops.

18. The method of claim 12, wherein reforming the double emulsion droplets comprises:
as the single emulsion droplets flow downstream in the spacing fluid, introducing the dispersing fluid into the channel at a location downstream of where the single emulsion droplets are manipulated and/or modified,
whereby, after the manipulation and/or modification, the single emulsion droplets enter the dispersing fluid and experience a change in surface wetting.

19. The method of claim 18, wherein the single emulsion droplets, after entering the dispersing fluid, are exposed to an inner surface of the channel configured to be non-wetting to the spacing fluid, and/or to a geometry configured for reforming double emulsion droplets from the single emulsion droplets.

20. The method of claim 12, wherein the dispersing fluid is immiscible with the spacing fluid.
